(19) United States
(12) Patent Application Publication
(10) Pub. No.: US 2008/0278520 A1
(43) Pub. Date: Nov. 13, 2008

(54) Methods, systems, and computer program products for modifying an electronic text message with warped images

(76) Inventor: Mans Folke Markus Andreasson, Lund (SE)

Correspondence Address: MYERS BIGEL SIBLEY & SAJOVEC, P.A., P.O. BOX 37428, RALEIGH, NC, 27627, US

(21) Appl. No.: 11/800,928

(22) Filed: May 8, 2007

(51) Int. Cl. G09G 5/00; G06F 17/00; H04M 1/00

(52) U.S. Cl. 345/647; 455/556.1; 455/550.1; 715/255

(57) ABSTRACT

Methods, devices, and computer program products modify an electronic text message with warped images. At least one emoticon is identified in an electronic text message. An image associated with a sender of the electronic text message is identified. The images warped based on the identified emoticon to provide a warped image. The warped images embedded in the electronic text message by replacing the at least one emoticon with the warped image.

### FIELD OF THE INVENTION

The present invention relates to electronic messages and may be particularly suited to electronic text messages sent or received on a mobile terminal.

### BACKGROUND OF THE INVENTION

Various shorthand notations have been developed for use with electronic messages. These shorthand notations are particularly useful when writing and sending electronic messages on a mobile terminal, such as a personal data assistance (PDA). These portable devices are generally relatively small, and typing long messages using a small keypad or touch sensitive screen may be cumbersome.

Shorthand notations indicating facial expressions can be particularly popular. These common notations include notations for a happy face “:)”, notations for a sad face “:(”, notations for a wink “;)”, and the like. In some cases, mobile terminals may substitute icons for such common facial expression notation. For example, a colon “:” followed by a parenthesis “)” indicates a happy face, and the mobile terminal may replace the text characters “:)” with the symbol “ [symbol] ”.

### SUMMARY OF THE INVENTION

According to embodiments of the present invention, methods, systems, and computer program products are provided that modify an electronic text message with warped images. At least one emoticon is identified in an electronic text message. An image associated with a sender of the electronic text message is identified. The image is warped based on the identified emoticon to provide a warped image. The warped image is embedded in the electronic text message, e.g., by replacing the at least one emoticon with the warped image.

In particular embodiments of the present invention, the electronic text message includes text with the warped image embedded therein. A number of pixels in the warped image can be reduced and/or resized before embedding the warped image in the text of the electronic text message. The image can be based on a digital photograph of the sender. The image may have a number of pixels that is less than the number of pixels of the digital photograph of the sender.

In some embodiments, the emoticon corresponds to one of a plurality of warping protocols, and warping the image based on the identified emoticon to provide a warped image is based on the corresponding one of the plurality of warping protocols

In certain embodiments, a subject is digitally photographed with a mobile terminal having a digital camera thereon. The digital photograph is stored on the mobile terminal to provide the image associated with a sender of electronic messages. The digital photograph can be warped to provide a warped image and to reduce a number of pixels stored on the mobile terminal.

In some embodiments, a computer program product for modifying electronic text messages includes a computer readable medium having computer readable program code embodied therein. The computer readable program code includes computer readable program code that identifies at least one emoticon in an electronic text message; computer readable program code that identifies an image associated with a sender of the electronic text message; computer readable program code that warps the image based on the identified emoticon to provide a warped image; and computer readable program code that embeds the warped image in the electronic text message.

In some embodiments, the computer readable program code that embeds the warped image in the electronic text message includes computer readable program code that replaces the at least one emoticon with the warped image. In some embodiments, the computer program product includes computer readable program code that reduces a number of pixels in the warped image in response to a size of the warped image to be displayed in the electronic text message. The computer program product may include computer readable program code that resizes the warped image before embedding the warped image in the text of the electronic message.

In particular embodiments, the image is based on a digital photograph of the sender. The warped image may have a number of pixels that is less than the number of pixels of the digital photograph of the sender. The emoticon may correspond to one of a plurality of warping protocols, and warping the image based on the identified emoticon to provide a warped image may be carried out using the corresponding one of the plurality of warping protocols.

In some embodiments, the computer program product includes computer readable program code that digitally photographs a subject with a mobile terminal having a digital camera thereon and computer readable program code that stores the digital photograph on the mobile terminal to provide the image associated with a sender of electronic messages. The computer program product can include computer readable program code that warps the digital photograph to generate the warped image, and to reduce a number of pixels stored on the mobile terminal for the warped image.

In some embodiments, a mobile terminal for modifying an electronic text message includes a warped image embedding module configured to identify at least one emoticon in an electronic text message, to identify an image associated with a sender of the electronic text message, to warp the image based on the identified emoticon to provide a warped image, and to embed the warped image in the electronic text message.

In particular embodiments, the mobile terminal includes a camera configured to capture a digitally photograph to provide the image associated with the sender.

### BRIEF DESCRIPTION OF THE DRAWINGS

FIG. 1 is a block diagram of data processing systems according to embodiments of the present invention;

FIG. 2 is a block diagram of a mobile terminal according to embodiments of the present invention;

FIG. 3 is a flowchart illustrating operations according to embodiments of the present invention; and

FIG. 4 is schematic diagraph illustrating warped images embedded in a text message according to embodiments of the present invention.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As will be appreciated by those of skill in the art, the present invention may be embodied as a method, data processing system, or computer program product. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code means embodied in the medium. Any suitable computer readable medium may be utilized including hard disks, CD-ROMs, optical storage devices, or magnetic storage devices.

Computer program code for carrying out operations of the present invention may be written in an object oriented programming language such as Java7, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to various embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

As used herein, a “mobile communications terminal” or “mobile terminal” includes, but is not limited to, a terminal that is configured to receive communication signals via a wireless interface from, for example, a cellular network, a Wide Area Network, wireless local area network (WLAN), and/or another RF communication device. Example mobile terminals include, but are not limited to, a cellular mobile terminal; a personal communication terminal that may combine a cellular mobile terminal with data processing, facsimile and data communications capabilities; a personal data assistance (PDA) that can include a wireless receiver, pager, Internet/intranet access, local area network interface, wide area network interface, Web browser, organizer, and/or calendar; and a mobile or fixed computer or other device that includes a wireless receiver.

As used herein, an “emoticon” is any combination of characters, such as characters commonly available on a typical keypad or keyboard, that may be used to symbolize a facial expression or mood. Examples of emoticons include happy “:)” or “:-)”, sad “:(”, winking “;)”, straight-faced “:|”, and the like. Emoticons are typically two to five characters on a single line used in text messages as informal markup to indicate emotions and/or attitudes that would otherwise be conveyed by body language or facial expressions in face-to-face communications. Emoticons can be relatively simple to type and can represent stylized facial expressions. Additional examples of emoticons include “pseudo-html” (<g> for “grin” or <rant> . . . </rant> to mark appropriate sections of text).

As used herein, the term “warp” refers to modifying a digital image by changing a feature relative to another feature. Examples of image warping include changing the relative spacing of features (such as bringing the eyes closer together or reducing the space between the eyes and the eyebrows), introducing various curvatures (such as making a straight feature curved), changing the color of features (such as red eyes for an angry expression) and the like. Examples of conventional image warping software include Morpheous Warping Software™ from Morpheous Software, Santa Barbara, Calif., U.S.A. or PhotoTwister™ from Scalado, Lund, Sweden.

According to embodiments of the current invention, emoticons can be identified in an electronic text message (e.g., such as a photograph of the sender). An image associated with a sender of the electronic message can also be identified. The image can be warped based on the identified emoticon to provide a warped image, e.g., that corresponds to the expression of the emoticon. The warped image can be embedded in the electronic text message. The electronic message, including the text in the warped image, can be displayed.

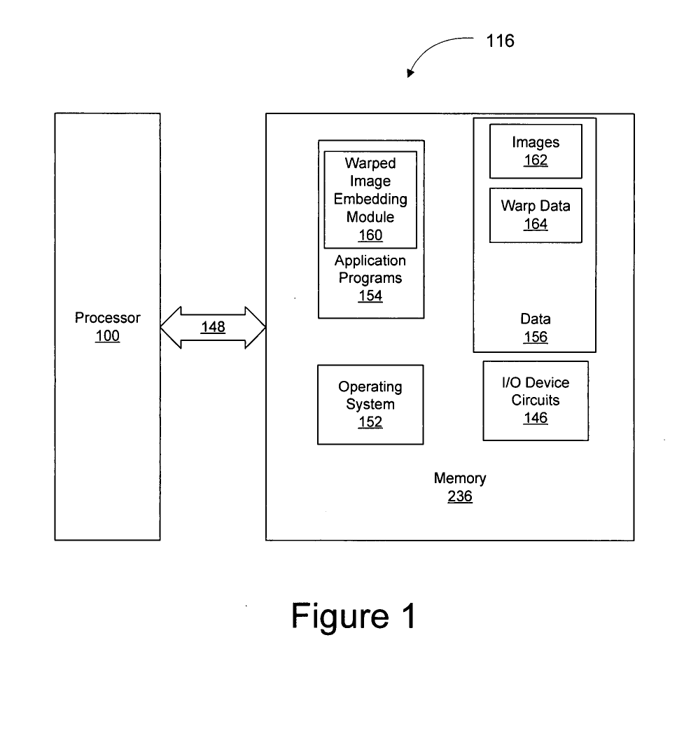

FIG. 1 illustrates an exemplary data processing system that may be included in a wireless terminal operating in accordance with some embodiments of the present invention. As illustrated in FIG. 1, a data processing system 116, which can be used to carry out or direct operations includes a processor 100, a memory 236 and input/output circuits 146. The data processing system may be incorporated in a portable wireless terminal and/or other components of a network, such as a server. The processor 100 communicates with the memory 236 via an address/data bus 148 and communicates with the input/output circuits 146 via an address/data bus 149. The input/output circuits 146 can be used to transfer information between the memory (memory and/or storage media) 236 and another component. These components may be conventional components such as those used in many conventional data processing systems, which may be configured to operate as described herein.

In particular, the processor 100 can be commercially available or custom microprocessor, microcontroller, digital signal processor or the like. The memory 236 may include any memory devices and/or storage media containing the software and data used to implement the functionality circuits or modules used in accordance with embodiments of the present invention. The memory 236 can include, but is not limited to, the following types of devices: cache, ROM, PROM, EPROM, EEPROM, flash memory, SRAM, DRAM and magnetic disk. In some embodiments of the present invention, the memory 236 may be a content addressable memory (CAM).

As further illustrated in FIG. 1, the memory (and/or storage media) 236 may include several categories of software and data used in the data processing system: an operating system 152; application programs 154; input/output device circuits 146; and data 156. Microsoft and Windows are trademarks of Microsoft Corporation in the United States, other countries, or both. The input/output device circuits 146 typically include software routines accessed through the operating system 152 by the application program 154 to communicate with various devices. The application programs 154 are illustrative of the programs that implement the various features of the circuits and modules according to some embodiments of the present invention. Finally, the data 156 represents the static and dynamic data used by the application programs 154 the operating system 152 the input/output device circuits 146 and other software programs that may reside in the memory 236.

The data processing system 116 may include several modules, including a warped image embedding module 160, and the like. The modules may be configured as a single module or additional modules otherwise configured to implement the operations described herein for warping an image and/or embedding the image in a text message. The data 156 can include images/sender data 162 and warp data 164, which may include a warping protocol for programmatically warping an image, e.g., based on an emoticon. For example, the warped image embedding module 160 can select an image from the images/sender data 162, and warp the image using a warping protocol from the warp data 164. The images/sender data 162 may include photographs of persons (or images based on photographs, such as images with a reduction in pixel number) or other images, such as images/photographs of animals. The images/sender data 162 may include information correlating images with a sender. When the sender of the message is identified, the image corresponding to the sender is warped by the warped image embedding module 160 (e.g., using a warping protocol associated with an identified emoticon) and embedded into the text of the message.

While the present invention is illustrated with reference to the warped image embedding module 160 and data 156 in FIG. 1, as will be appreciated by those of skill in the art, other configurations fall within the scope of the present invention. For example, rather than being an application program 154, these circuits and modules may also be incorporated into the operating system 152 or other such logical division of the data processing system. Furthermore, while the warped image embedding module 160 in FIG. 1 is illustrated in a single data processing system, as will be appreciated by those of skill in the art, such functionality may be distributed across one or more data processing systems. Thus, the present invention should not be construed as limited to the configurations illustrated in FIG. 1, but may be provided by other arrangements and/or divisions of functions between data processing systems. For example, although FIG. 1 is illustrated as having various circuits and modules, one or more of these circuits or modules may be combined, or separated further, without departing from the scope of the present invention.

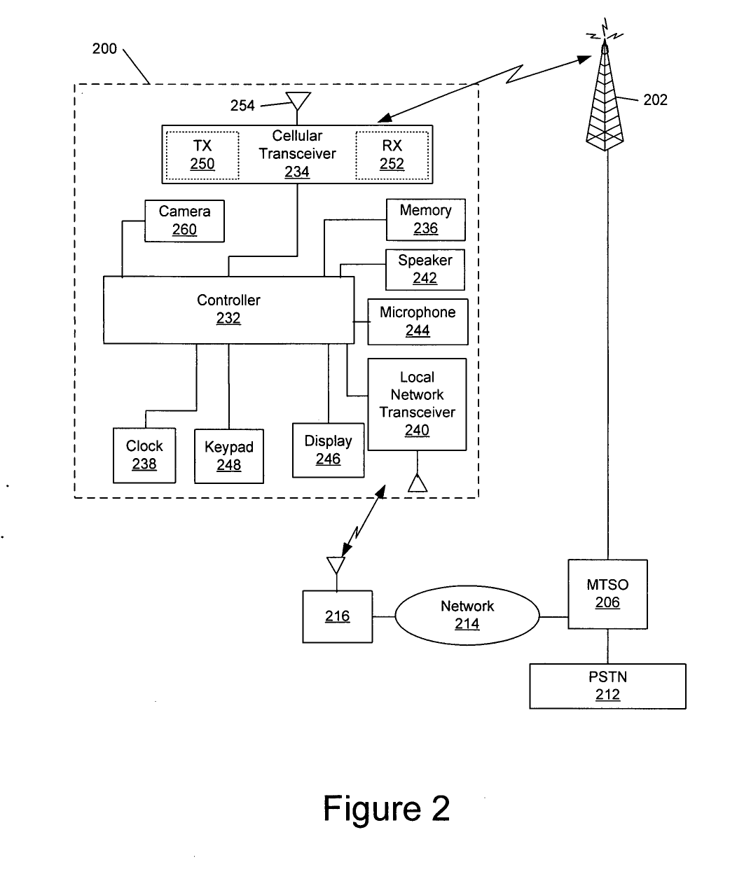

FIG. 2 is a schematic block diagram of a wireless communication system that includes a wireless terminal 200, such as a mobile wireless communications terminal, that receives wireless communication signals from a cellular base station 202 and/or a wireless local network 216. The cellular base station 202 is connected to a MTSO 206, which, in turn, is connected to a PSTN 212, and a network 214 (e.g., Internet). The mobile terminal 200 may communicate with the wireless local network 216 using a communication protocol that may include, but is not limited to, 802.11a, 802.11b, 802.11e, 802.11g, 802.11i, and/or other wireless local area network protocols. The wireless local network 216 may be connected to the network 214.

In some embodiments of the invention, the mobile terminal 200 includes various components, such as a camera 260, a controller 232, a cellular transceiver 234, a memory 236, a timing circuit (clock) 238, a local network transceiver 240, a speaker 242, a microphone 244, a display 246 and a keypad 248.

The memory 236 stores software (e.g., as described in FIG. 1) that is executed by the controller 232, and may include one or more erasable programmable read-only memories (EPROM or Flash EPROM), battery backed random access memory (RAM), magnetic, optical, or other digital storage device, and may be separate from, or at least partially within, the controller 232. The controller 232 may include more than one processor, such as, for example, a general purpose processor and a digital signal processor, which may be enclosed in a common package or separate and apart from one another.

In particular, the controller 232 may be configured to control various functions of the wireless terminal 200, including embedding warped images into text messages for display on the display 214 of the wireless terminal 200 as described herein.

As shown in FIG. 2, the cellular transceiver 234 typically includes both a transmitter (TX) 250 and a receiver (RX) 252 to allow two way communications, but the present invention is not limited to such devices and, as used herein, a “transceiver” may include only the receiver 252. The mobile terminal 200 may thereby communicate with the base station 202 using radio frequency signals, which may be communicated through an antenna 254. For example, the mobile terminal 200 may be configured to communicate via the cellular transceiver 234 using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and Universal Mobile Telecommunications System (UMTS). Communication protocols as used herein may specify the information communicated, the timing, the frequency, the modulation, and/or the operations for setting-up and/or maintaining a communication connection. In some embodiments, the antennas 228 and 254 may be a single antenna.

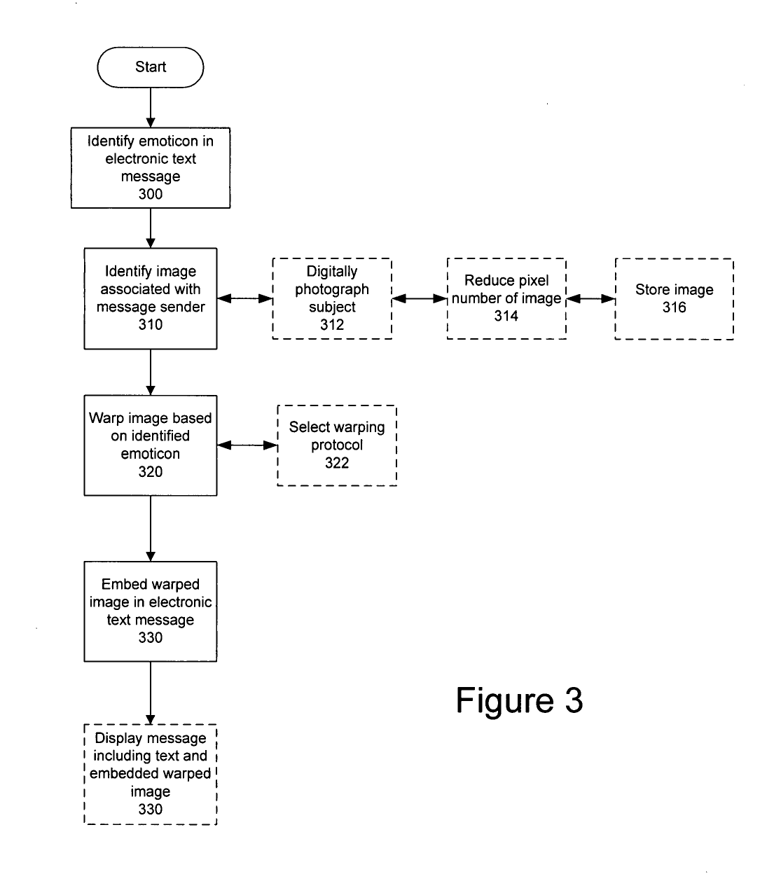

Embodiments of the present invention will now be described with reference to FIG. 3, which is a flowchart illustration of operations, which may be at least partially carried out on the controller 232 and/or the warped image embedding module 160, according to embodiments of the present invention.

As illustrated in FIG. 3, at least one emoticon is identified in an electronic text message (block 300). An image associated with a sender of the electronic message is identified (block 302). For example, the image/sender data 162 can include images stored with associated identities of senders (e.g., names, e-mail addresses, and the like). The sender of an electronic message can be identified and based on, for example, an e-mail address, and the associated image is identified. The image associated with the sender can be a digital photograph of the sender. In some embodiments, any image can be selected by a user and stored in memory so that it is associated with the sender and inserted as described herein in electronic text messages from the sender. For example, the sender or recipient of the text message can select a particular image of the sender or another person or animal to be associated with the sender. The image is then warped according to a warping protocol based on the identified emoticon to provide a warped image (320). For example, the warped data 164 (FIG. 1) can include a plurality of warping protocols corresponding to emoticons. When an emoticon is identified in a message, the associated warping protocol can be used to warped the image associated with the sender. The warped image is embedded in the electronic text message (330). The electronic text message including text and the warped image embedded therein may then be displayed (340) on the display 246.

In particular embodiments, the warped image is based on a digital photograph and has a number of pixels that is less than the number of pixels of the corresponding digital photograph. For example, as shown in FIG. 3, a subject can be digitally photographed (block 312) with the mobile terminal 200 using the camera 260. The number of pixels from the digital photograph may be reduced (block 314) and the resulting image may be stored (block 316) on the mobile terminal 200. In particular embodiments, reducing the number of pixels in the stored image may facilitate data storage, for example, when the image is stored on the mobile terminal 200, which may have a limited amount of memory. Reducing the number of pixels may conserve memory on the mobile terminal 200 and/or reduce bandwidth required to transmit the message to another terminal. The number of pixels may be reduced based on a desired size of the warped image on the display 246, for example, so that the image can be embedded in the text. Moreover, when the warped images are embedded in an electronic text message and displayed, for example, on a display of the mobile terminal 200, high-resolution images (i.e., with relatively large numbers of pixels, such as greater than 640×480 pixels or 0.3 megapixels or 3-5 megapixels or more) may not be necessary due to the relatively small area in which the warped images displayed. For example, in certain embodiments, the warped image can have 128×128 or 32×32 pixels or less.

In some embodiments, the same mobile terminal may be used to capture digital photographs (block 312), store the photographs as images with reduced pixel numbers (block 314), and to receive electronic text messages including emoticons (block 316). The mobile terminal can then identify the stored image associated with the message sender (block 310), warp the image based on the identified emoticon (block 320), embed the warped image in the electronic text message by replacing the emoticon with the warped image (block 330), and display the text message (block 340).

As will be readily understood by one of skill in the art, the image(s) may be stored on the processing system 116 of FIG. 1, which may be a personal computer, laptop or a mobile terminal 200 as shown in FIG. 2. However, the image(s) may be stored on a component of a network 214 shown in FIG. 2, such as a server. Moreover, operations according to the present invention can be performed in a client-server architecture by various components thereof or may be provided as a stand-alone application.

In particular embodiments, various warping protocols may be selected based on the identified emoticon(s) in an electronic text message (block 322). For example, if the image is an image of a face (such as a digital photograph of the sender) an emoticon indicating a happy face, e.g., “:-)” or “:)” may be used to select warping protocol that curves the mouth portion of the image upwardly on the ends of the mouth so that the image reflects a smile.

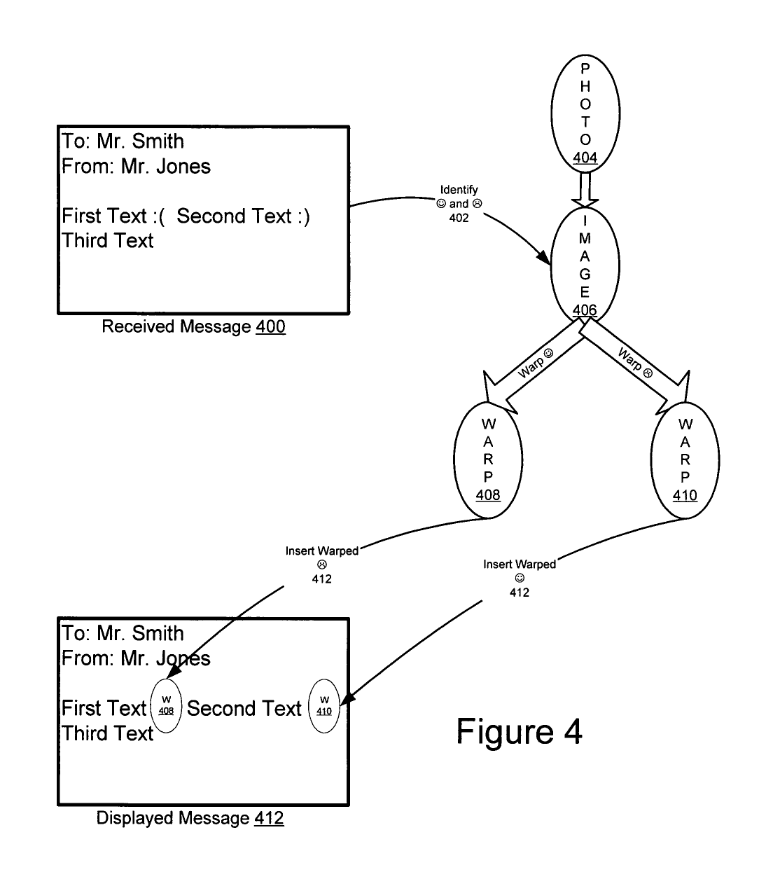

As shown in FIG. 4, a digital photograph 404 can be converted to an image 406, for example by reducing the number of pixels to facilitate storage of the image 406. An electronic text message 400 can be received by a terminal, such as the mobile terminal 200 in FIG. 2. The emoticons “:(” and “:)” (illustrated as [symbol] and [symbol] , respectively) are identified in the text message 400 at arrow 402, for example, by the warped image embedding module 160 of FIG. 1. A warping protocol from a plurality of warping protocols can be selected to provide a facial expression based on the emoticon. In response to a “:(” emoticon, the image 406 is warped using a selected warping protocol to provide a sad facial expression (i.e., the [symbol] warped image 408). In contrast, in response to the “:)” emoticon, the image 406 is warped using a warping protocol that provides a happy/humorous facial expression (i.e., the [symbol] warped image 410). As illustrated with arrows 412, the warped images 408 and 410 are then inserted in the message 400 as shown in a displayed message 412. As illustrated in FIG. 4, the displayed warped images 408 and 410 may be resized, for example, so as to reduce interference with the size of the text of the displayed message 412 and to facilitate transmission of the modified message to another terminal. In some embodiments, the number of pixels of the warped images 408 and 410 can also be reduced.

In the drawings and specification, there have been disclosed typical embodiments of the invention and, although specific terms are employed, they are used in a generic and descriptive sense only and not for purposes of limitation, the scope of the invention being set forth in the following claims.

That which is claimed:

1. A method of modifying an electronic text message:
identifying at least one emoticon in an electronic text message;
identifying an image associated with a sender of the electronic text message;
warping the image based on the identified emoticon to provide a warped image; and
embedding the warped image in the electronic text message.

2. The method of claim 1, wherein embedding the warped image in the electronic text message includes replacing the at least one emoticon with the warped image.

3. The method of claim 1, further comprising reducing a number of pixels in the warped image in response to a size of the warped image to be displayed in the electronic text message.

4. The method of claim 3, further comprising resizing the warped image before embedding the warped image in the text of the electronic message.

5. The method of claim 1, wherein the image is based on a digital photograph of the sender.

6. The method of claim 5, wherein the warped image has a number of pixels that is less than the number of pixels of the digital photograph of the sender.

7. The method of claim 1, wherein the emoticon corresponds to one of a plurality of warping protocols, and warping the image based on the identified emoticon to provide a warped image is carried out using the corresponding one of the plurality of warping protocols.

8. The method of claim 1, further comprising:
digitally photographing a subject with a mobile terminal having a digital camera thereon; and
storing the digital photograph on the mobile terminal to provide the image associated with a sender of electronic messages.

9. The method of claim 8, further comprising:
warping the digital photograph to generate the warped image, and to reduce a number of pixels stored on the mobile terminal for the warped image.

10. A computer program product for modifying electronic text messages, the computer program product comprising:
a computer readable medium having computer readable program code embodied therein, the computer readable program code comprising:
computer readable program code that identifies at least one emoticon in an electronic text message;
computer readable program code that identifies an image associated with a sender of the electronic text message;
computer readable program code that warps the image based on the identified emoticon to provide a warped image; and
computer readable program code that embeds the warped image in the electronic text message.

11. The computer program product of claim 10, wherein the computer readable program code that embeds the warped image in the electronic text message includes computer readable program code that replaces the at least one emoticon with the warped image.

12. The computer program product of claim 10, further comprising computer-readable program code that reduces a number of pixels in the warped image in response to a size of the warped image to be displayed in the electronic text message.

13. The computer program product of claim 12, further comprising computer readable program code that resizes the warped image before embedding the warped image in the text of the electronic message.

14. The computer program product of claim 10, wherein the image is based on a digital photograph of the sender.

15. The computer program product of claim 14, wherein the warped image has a number of pixels that is less than the number of pixels of the digital photograph of the sender.

16. The computer program product of claim 10, wherein the emoticon corresponds to one of a plurality of warping protocols, and warping the image based on the identified emoticon to provide a warped image is carried out using the corresponding one of the plurality of warping protocols.

17. The computer program product of claim 10, further comprising:
computer readable program code that digitally photographs a subject with a mobile terminal having a digital camera thereon; and
computer readable program code that stores the digital photograph on the mobile terminal to provide the image associated with a sender of electronic messages.

18. The computer program product of claim 17, further comprising computer readable program code that warps the digital photograph to generate the warped image, and to reduce a number of pixels stored on the mobile terminal for the warped image.

19. A mobile terminal for modifying an electronic text message:
a warped image embedding module configured to identify at least one emoticon in an electronic text message, to identify an image associated with a sender of the electronic text message, to warp the image based on the identified emoticon to provide a warped image, and to embed the warped image in the electronic text message.

20. The mobile terminal of claim 19, further comprising a camera configured to capture a digitally photograph to provide the image associated with the sender.
